(19) United States
(12) Patent Application Publication
(10) Pub. No.: US 2025/0013407 A1
(43) Pub. Date: Jan. 9, 2025

(54) IMAGE PROCESSING DEVICE, TERMINAL DEVICE, AND RESPONSE METHOD

(71) Applicant: SHARP KABUSHIKI KAISHA, Sakai City (JP)

(72) Inventor: Akitoshi MASUDA, Sakai City (JP)

(21) Appl. No.: 18/754,211

(22) Filed: Jun. 26, 2024

(30) Foreign Application Priority Data
Jul. 3, 2023 (JP) 2023-109530

(51) Int. Cl. G06F 3/12

(52) U.S. Cl. CPC G06F 3/1255; G06F 3/1206; G06F 3/121; G06F 3/1239; G06F 3/1254

(57) ABSTRACT

An image processing device includes an image processor that processes document data described in a predetermined document format, and one or more controllers that control a response to an acquisition request of capability information from a terminal device in accordance with a status of compatibility of the image processor with the predetermined document format. Even when there is incompatibility with a first document format as a capability of the image processor, the one or more controllers receive a setting of enabling or disabling a print function for the document data and respond to the acquisition request of the capability information.

### CROSS-REFERENCE TO RELATED APPLICATION

The present application claims priority from Japanese Application JP2023-109530, the content of which is hereby incorporated by reference into this application.

### BACKGROUND OF THE INVENTION

### 1. Field of the Invention

The present disclosure relates to an image processing device and the like.

### 2. Description of the Related Art

A printer driver supplied by a vendor that provides an image processing device is configured to maximize the capability of the image processing device. However, the printer driver supplied by the vendor needs to be individually installed for each device by a user who uses the image processing device. Thus, it is troublesome for the user.

On the other hand, a standard printer driver incorporated in an operating system (OS) in advance does not need to be individually installed by the user who uses the image processing device. However, available functions are limited to standard functions in order to support various types of image processing devices.

In view of such circumstances, efforts for fully utilizing the capability of the image processing device have been recently made by installing a print support application (PSA) that supports printing using the standard printer driver.

### SUMMARY OF THE INVENTION

An object of the present disclosure is to provide an image processing device and the like capable of executing print processing based on a print function provided by a PSA even when the image processing device is incompatible with a specific document format.

In order to solve the above problem, an image processing device according to the present disclosure includes an image processor that processes document data described in a predetermined document format, and a controller that controls a response to an acquisition request of capability information from a terminal device in accordance with a status of compatibility of the image processor with the predetermined document format, wherein even when there is incompatibility with a first document format as a capability of the image processor, the one or more controllers receive a setting of enabling or disabling a print function for the document data and respond to the acquisition request of the capability information.

A terminal device according to the present disclosure includes a storage that stores an application program supporting a print setting corresponding to an image processing device in cooperation with a printer driver, a controller that functions as a print support application by reading the application program stored in the storage, wherein based on capability information acquired from the image processing device, the controller outputs, to the image processing device, a print instruction in a document format with which the image processing device is compatible.

A response method according to the present disclosure includes controlling a response to an acquisition request of capability information from a terminal device in accordance with a status of compatibility with a predetermined document format, and receiving a setting of enabling or disabling a print function for document data described in the predetermined document format and responding to the acquisition request of the capability information even when there is incompatibility with a first document format as a capability of processing the document data.

According to the present disclosure, it is possible to provide an image processing device and the like capable of executing print processing based on a print function provided by a PSA even when the image processing device is incompatible with a specific document format.

### BRIEF DESCRIPTION OF THE DRAWINGS

FIG. 1 is a diagram for explaining a connection mode of a multifunction peripheral, a client PC, and an application distribution server according to a first embodiment.

FIG. 2 is a diagram for explaining a functional configuration of the multifunction peripheral according to the first embodiment.

FIG. 3 is a diagram for explaining a functional configuration of the client PC according to the first embodiment.

FIG. 4 is a sequence diagram for explaining addition processing of the multifunction peripheral according to the first embodiment.

FIG. 5 is a flowchart for explaining a procedure according to the first embodiment.

FIG. 6 is a flowchart for explaining a procedure according to the first embodiment.

FIG. 7 is a flowchart for explaining a procedure according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining activation processing of a PSA according to a second embodiment.

### DETAILED DESCRIPTION OF THE INVENTION

Embodiments according to the present disclosure will be described below with reference to the drawings. Note that the following embodiments are examples for explaining the present disclosure, and the technical content of the explanation described in the claims is not limited to the following description.

When an image processing device such as a multifunction peripheral is controlled to process a print job, a terminal device generates the print job via a dedicated printer driver installed in an operating system (OS) or a standard printer driver provided as a standard function of the OS. In general, the dedicated printer driver installed in the OS for use is provided by the vendor of the image processing device and is configured so that the capability of the image processing device can be fully exerted.

On the other hand, for versatility of enabling printing in many (various) image processing devices, the standard printer driver only supports a common function of each image processing device in many cases. Even in the case of processing a print job using the standard printer driver, a print result similar to that in the case of using the dedicated printer driver has been recently required in many cases. In addition, in order to improve the stability and security of the OS, the vendor providing the OS has made an effort to expand the function of the standard printer driver.

As one aspect of the above effort, a PSA is known that supports processing of a print job by the standard printer driver. In general, the PSA is supplied as an application by the vendor or the like that provides the OS or the image processing device. The PSA is configured to cooperate with the standard printer driver so as to be able to fully exert the function of the image processing device based on acquired capability information of the image processing device. For example, the PSA transmits, as a print job, a job described in a standard Page Description Language (PDL) such as XML Paper Specification (XPS), Portable Document Format (PDF), or PostScript or a job extended by adding additional data such as a Print Job Language (PJL) command to the PDL to the image processing device.

The Internet Printing Protocol (IPP) is known as a communication protocol for transmitting and/or receiving the print job and necessary information between the image processing device and the terminal device. In the IPP, the print job is represented by document data in a predetermined PDL format and IPP attribute information. Here, the IPP attribute information is, for example, attribute information related to the image processing device or a job corresponding to a printer operation such as “Print-Job (print execution)” or “Get-Printer-Attributes (printer attribute acquisition)” or a job operation such as “Get-Job-Attributes (job state acquisition)” or “Cancel-Job (job cancellation)”. For example, in the case of the printer operation related to “Get-Printer-Attributes (printer attribute acquisition)”, the image processing device transmits, as definition information, capability information related to its own output capability (processing capability such as a supported (compatible) document format, the maximum number of copies, a finisher type, and print quality) to the inquiry source (terminal device).

Some image processing devices are incompatible with PostScript as a first document format for PDF printing or compatible with PostScript as an option that needs to be activated with a product key, for example.

In order for an image processing device incompatible with PostScript to be compatible with a PSA that transmits document data described in Printer Control Language (PCL) as a second document format capable of vendor-specific representation, enabling or disabling of the PSA first needs to be set regardless of whether or not there is compatibility with PostScript, and a terminal device installed with the PSA secondly needs to identify whether the image processing device is compatible with either or both of PCL and PostScript and transmit a job in a document format suitable for the image processing device.

An image processing device that is incompatible with a specific document format but can execute print processing based on a print function provided by a PSA is achieved in the following embodiments.

### 1. First Embodiment

### 1.1 Overall Configuration

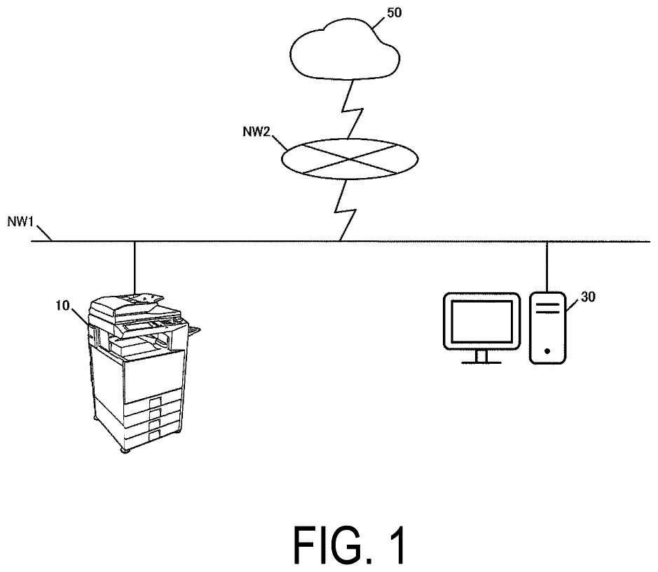

FIG. 1 is a diagram for explaining an example of a connection mode of a multifunction peripheral 10 as an image processing device, a client personal computer (PC) 30 as a terminal device, and an application distribution server 50 that distributes an application such as a PSA according to a first embodiment.

The multifunction peripheral 10, the client PC 30, and the application distribution server 50 according to the first embodiment are communicably connected to each other via communication lines such as networks NW1 and NW2. The multifunction peripheral 10 is an image processing device that can execute each of jobs such as print, copy, fax, and image transmission in one housing. The multifunction peripheral 10 can print document data on a paper medium based on a print job received from the client PC 30 or transmit the document data attached to an e-mail.

The client PC 30 can be configured as a computer capable of operating based on a specific operating system (OS). The client PC 30 can generate a print job based on a standard printer driver incorporated in the OS in advance and transmit the print job to the multifunction peripheral 10 via the network NW1. Further, the client PC 30 can acquire an application such as a PSA from the application distribution server 50 by downloading or the like.

Although FIG. 1 illustrates a mode in which one multifunction peripheral 10 and one client PC 30 are connected to the networks NW1 and NW2, a plurality of multifunction peripherals 10 and a plurality of clients PCs 30 may be connected to the networks NW1 and NW2.

### 1.2 Functional Configuration

### 1.2.1 Multifunction Peripheral 10

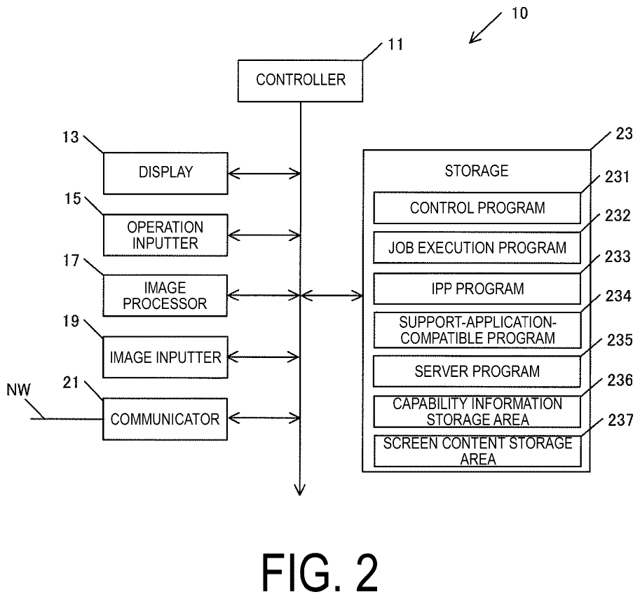

A functional configuration of the multifunction peripheral 10 will be described. FIG. 2 is a diagram for explaining the functional configuration of the multifunction peripheral 10. The multifunction peripheral 10 includes a controller 11, a display 13, an operation inputter 15, an image processor 17, an image inputter 19, a communicator 21, and a storage 23.

The controller 11 controls the entire multifunction peripheral 10. The controller 11 is configured of, for example, one or multiple arithmetic devices (central processing units (CPUs) or the like). The controller 11 implements its functions by reading and executing various programs stored in the storage 23.

The display 13 is a display device that displays various types of information for a user or the like. The display 13 can be configured of, for example, a liquid crystal display (LCD) or an organic electro-luminescence (EL) display.

The operation inputter 15 is an input device that receives input of information by the user or the like. The operation inputter 15 can be configured of, for example, various input devices such as operation keys (for example, hardware keys and software keys) and buttons. Note that the operation inputter 15 can be configured as a touch panel display that enables input via the display 13. In this case, as an input system for the touch panel, for example, a general system such as a resistance film system, an electromagnetic induction system, or an electrostatic capacitance system can be employed.

The image processor 17 includes an image former (print engine) that interprets document data described in a predetermined document format and forms an image based on the interpreted document data on a paper medium such as paper. The image former feeds paper from a feed tray (not illustrated), forms an image on the paper based on document data included in a print job, and then discharges the paper to a paper discharger (not illustrated). The image former can be configured of, for example, a laser printer using an electrophotographic system. In this case, the image former performs image formation using toners supplied from toner cartridges (not illustrated) corresponding to toner colors (for example, cyan, magenta, yellow, and black). The image processor 17 may also perform, for example, shading correction or density correction on document data input from the image inputter 19 to generate output data for image transmission.

The image processor 17 according to the first embodiment executes image processing (image formation) by interpreting document data described in various document formats such as PCL, Joint Photographic Experts Group (JPEG), Printer Working Group (PWG), and Plain (ASCII) text as second document formats capable of vendor-specific representation. In the description, it is assumed that the image processor 17 according to the first embodiment is configured to be incompatible with PostScript as the first document format and not to be capable of executing image processing on document data described in PDL related to PostScript including PDF.

The image inputter 19 generates document data by scanning a document. The image inputter 19 can be configured as a scanner device that is provided with an image sensor such as a charge coupled device (CCD) or a contact image sensor (CIS) and that includes an automatic document feeder (ADF), a flatbed on which a document is placed to be read, and the like. The configuration of the image inputter 19 is not particularly limited as long as the image inputter 19 can generate image data by reading a reflected light image from a document image using the image sensor. Note that the image inputter 19 also can be configured as an interface that can acquire, for example, document data stored in a portable storage medium such as a universal serial bus (USB) memory stick and a print job transmitted from the client PC 30.

The communicator 21 includes one or both of wired and wireless interfaces for performing communication with another device (such as the client PC 30) via the networks NW1 and NW2 such as a local area network (LAN), a wide area network (WAN), the Internet, or a telephone line. Note that the communicator 21 may include an interface related to a (short-range) wireless communication technology such as Bluetooth (trade name), near field communication (NFC), Wi-Fi (trade name), ZigBee (trade name), IrDA, or wireless USB.

The storage 23 stores various programs and various types of data necessary for operation of the multifunction peripheral 10. The storage 23 can be configured of, for example, a storage device (memory) such as a random access memory (RAM), a hard disk drive (HDD), a solid state drive (SSD), or a read only memory (ROM).

In the first embodiment, the storage 23 stores a control program 231, a job execution program 232, an IPP program 233, a support-application-compatible program 234, and a server program 235. The storage 23 includes a capability information storage area 236 and a screen content storage area 237.

The control program 231 is a program that the controller 11 reads when performing centralized control of the multifunction peripheral 10. The controller 11 that has read the control program 231 functions as the image processing device according to the present disclosure by controlling driving of the display 13, the operation inputter 15, the image processor 17, the image inputter 19, the communicator 21, and the like.

The job execution program 232 analyzes a job received from the client PC 30, and when the received job is a print job and document data included in the print job is described in a document format interpretable by the image processor 17, the job execution program 232 executes a print job based on the document data. Note that when the received job is a transmission job related to fax, image transmission, or the like, the communicator 21 or the like is controlled to execute the job related to fax or image transmission.

The IPP program 233 is a program that the controller 11 reads when performing communication with the client PC 30 using the IPP. The controller 11 that has read the IPP program 233 transmits identification information of the multifunction peripheral 10 such as a device name and a device ID, and capability information such as a supported (compatible) document format, the maximum number of copies, a finisher type, and print quality, to the client PC 30 as definition information as a response to an operation (capability information acquisition request) related to “Get-Printer-Attributes” from the client PC 30. The controller 11 reads the IPP program 233, so that a multicast Domain Name System (mDNS) service can be provided.

The support-application-compatible program 234 is a program that the controller 11 reads when bringing the multifunction peripheral 10 into a device state in which a function provided by the PSA can be implemented (for example, response to a capability information acquisition request and execution of a print job based on a print function of the PSA). Note that, in the present disclosure, the device state of the multifunction peripheral 10 in which the function provided by the PSA can be implemented may be referred to as “the PSA function is enabled”. The controller 11 that has read the support-application-compatible program 234 can implement the function provided by the PSA by cooperating with the job execution program 232, the IPP program 233, and the like. Note that, as will be described below, the support-application-compatible program 234 may be appropriately read in accordance with a setting of enabling/disabling the PSA function via the system setting screen or may be mounted as firmware and read along with activation processing of the multifunction peripheral 10.

The server program 235 is a program that the controller 11 reads when displaying, on a browser, a setting screen or the like for receiving device settings of the multifunction peripheral 10. The controller 11 that has read the server program 235 functions as a server that provides the browser with screen information by directly specifying a screen content stored in the screen content storage area 237 or by specifying a file path in response to a display request from the browser.

The capability information storage area 236 is an area for storing capability information of the multifunction peripheral 10 transmitted in response to a capability information acquisition request from the client PC 30.

The screen content storage area 237 is an area for storing a screen content for displaying a setting screen or the like. The screen content stored in the screen content storage area 237 is appropriately read by the controller 11 functioning as a server and is used for screen rendering of the setting screen or the like.

### 1.2.2 Client PC 30

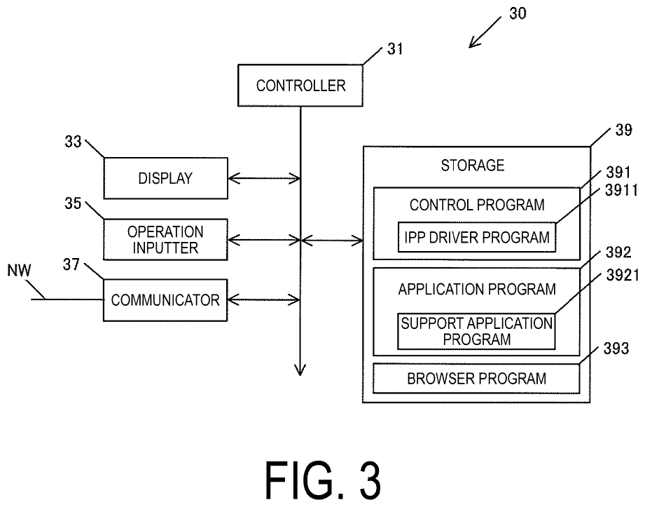

Next, the client PC 30 will be described. FIG. 3 is a diagram for explaining a functional configuration of the client PC 30. The client PC 30 includes a controller 31, a display 33, an operation inputter 35, a communicator 37, and a storage 39.

The controller 31 controls the entire client PC 30. The controller 31 is configured of, for example, one or multiple arithmetic devices (such as CPUs). The controller 31 implements its function by reading and executing various programs stored in the storage 39.

The display 33 is a display device that displays various types of information for a user or the like. The display 33 can be configured of, for example, an LCD or an organic EL display.

The operation inputter 35 is an input device that receives input of information by the user or the like. As the operation inputter 35, an input device such as a keyboard, a mouse, or a touch panel can be used.

The communicator 37 includes one or both of wired and wireless interfaces for performing communication with another device (e.g., the multifunction peripheral 10) via, for example, a LAN, a WAN, the Internet, or a telephone line. Note that the communicator 37 may include an interface related to a (short-range) wireless communication technology such as Bluetooth (trade name), near field communication (NFC), Wi-Fi (trade name), ZigBee (trade name), IrDA, or wireless USB.

The storage 39 is a storage device that stores various programs and various types of data necessary for operation of the client PC 30. The storage 39 can be configured of a storage device (memory) such as a RAM, an HDD, an SSD, or a ROM.

In the first embodiment, the storage 39 includes a control program 391, an application program 392, and a browser program 393.

The control program 391 is a program that the controller 31 reads when performing centralized control of the client PC 30. The controller 31 that has read the control program 391 functions as an OS and, for example, controls driving of hardware such as the display 33, the operation inputter 35, and the communicator 37, activates and terminates an application driven on the OS, and manages files.

The control program 391 includes an IPP driver program 3911 as a standard printer driver. The controller 31 that has read the IPP driver program 3911 performs communication with the multifunction peripheral 10 in conformity with the IPP. The controller 31 that has read the IPP driver program 3911 searches for the multifunction peripheral 10 or the like and transmits a capability information acquisition request or a generated print job to the multifunction peripheral 10 or the like based on the IPP.

The application program 392 is a program that the controller 31 reads upon receipt of an activation instruction from the user. The controller 31 that has read the application program 392 provides a specific function corresponding to the user's purpose, such as document creation, graphic rendering, and Internet browsing. The application program 392 can be acquired by installation using a recording medium such as a CD or a DVD, downloading from a service providing server (not illustrated), or the like.

The application program 392 includes a support application program 3921. The support application program 3921 is an extended program that is read by the controller 31 to function as a PSA operating on the OS and that improves and enhances a print result in cooperation with the standard printer driver. When activated as the PSA, the controller 31 generates a print setting screen (UI) for receiving print settings corresponding to the multifunction peripheral 10 or the like and displays the print setting screen on the display 33. The controller 31 stores the print settings received via the print setting screen in the storage 39. Then, upon receipt of input of a print execution instruction, the controller 31 generates a print job reflecting the stored print settings and transmits the print job to the target multifunction peripheral 10 or the like.

The browser program 393 is a program that the controller 31 reads when rendering screen information for screen display and displaying a screen for browsing on the display 33. The controller 31 that has read the browser program 393 can generate the screen for browsing by rendering the screen information acquired via the server function provided by the multifunction peripheral 10 and display the screen as a Web-UI on the display 33.

### 1.2.3 Application Distribution Server 50

The configuration of the application distribution server 50 is not particularly limited as long as the application distribution server 50 can provide an application such as a PSA in response to an acquisition request from the client PC 30, and a known configuration can be used. Thus, description of the functional configuration of the application distribution server 50 is omitted.

### 1.3 Procedure

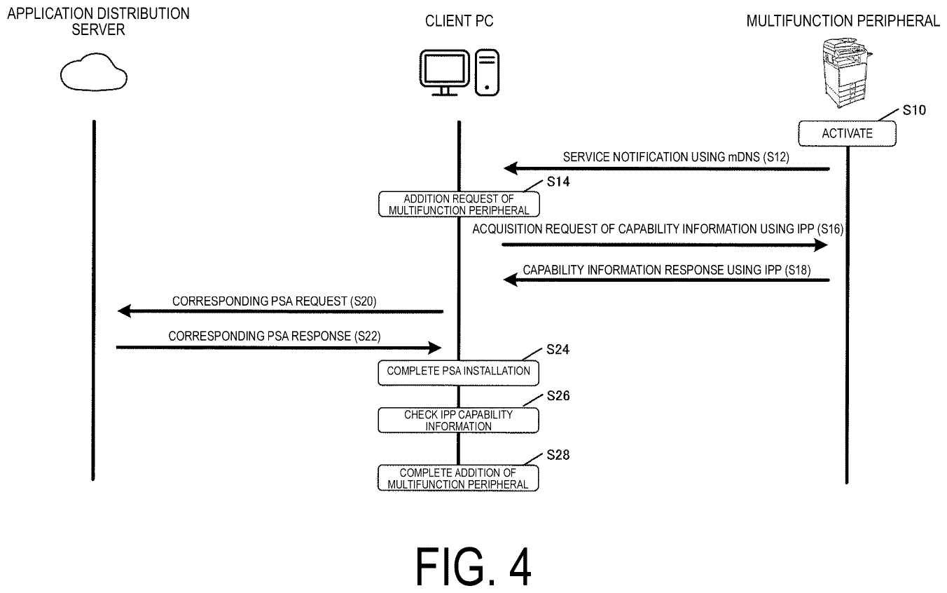

Next, a procedure according to the first embodiment will be described. FIG. 4 is a sequence diagram for explaining processing of adding the multifunction peripheral 10 to the client PC 30. In the explanation of FIG. 4, an aspect in which the controller 31 of the client PC 30 functions as an OS by reading the control program 391 including the IPP driver program 3911 is simply referred to as an OS, and a PSA operating on the OS is simply referred to as a PSA.

First, a user activates the multifunction peripheral 10 (S10). The controller 11 of the multifunction peripheral 10 starts an mDNS service by reading the IPP program 233 and the support-application-compatible program 234. The controller 11 of the multifunction peripheral 10 notifies the mDNS service by transmitting an mDNS packet (S12).

The OS of the client PC 30 starts searching among image processing devices including the multifunction peripheral 10. When the search among the image processing devices is performed, the multifunction peripheral 10 notifying the mDNS service is hit in the search. At this time, an image processing device not notifying the mDNS service is not hit in the search.

The OS of the client PC 30 displays a list of search results on the display 33 and receives a selection of a multifunction peripheral 10 desired to be added (S14). Upon receipt of the selection (addition request) of the multifunction peripheral 10 by the user, the OS of the client PC 30 makes an acquisition request of capability information related to “Get-Printer-Attributes” to the multifunction peripheral 10 (S16).

The multifunction peripheral 10 responds to the acquisition request of the capability information by transmitting, as definition information, identification information and capability information such as print quality of the multifunction peripheral 10 to the OS of the client PC 30 (S18).

In S18, a “Printer-device-id” is one piece of the definition information sent back to the OS of the client PC 30. A “Compatible ID” is included in the “Printer-device-id”. Here, the “Compatible ID” represents a compatibility identifier of the multifunction peripheral 10. The “Compatible ID” is an identifier used when the OS of the client PC 30 determines an extended INF (setup information file) (not illustrated) to be installed.

The OS of the client PC 30 installs an extended INF (not illustrated) corresponding to the “Compatible ID”. Note that the identifier of the corresponding support application program 3921 is described in the extended INF. The OS of the client PC 30 requests the corresponding support application program 3921 from the application distribution server 50 based on the identifier of the support application program 3921 described in the extended INF (S20).

The application distribution server 50 responds to the corresponding PSA request by transmitting the corresponding support application program 3921 to the client PC 30 (S22).

The OS of the client PC 30 that has acquired the corresponding support application program 3921 installs the support application program 3921. Upon completion of the installation of the support application program 3921 (S24), the OS of the client PC 30 activates a PSA by reading the support application program 3921.

The activated PSA checks the capability information (definition information) acquired in S18 (S26). Then, based on the result of checking the capability information related to S26, the PSA adds the multifunction peripheral 10 that has been selected in S14, and thus the processing ends (S28).

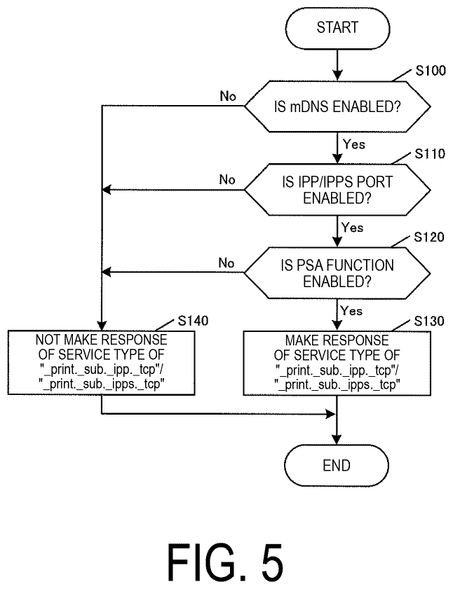

Next, processing executed by the multifunction peripheral 10 at the time of activation will be described with reference to a flowchart of FIG. 5.

The controller 11 of the multifunction peripheral 10 that has started being activated determines whether or not a service related to the mDNS is enabled (step S100). When determining that the service related to the mDNS is enabled, the controller 11 determines whether or not an IPP/IPPS port is enabled (Yes in step S100 and proceeding to step S110). When it is determined that the IPP/IPPS port is enabled, the controller 11 determines whether or not a PSA function is enabled (Yes in step S110 and proceeding to step S120).

When it is determined that the PSA function is enabled, the controller 11 responds to the OS of the client PC 30 by notifying the service type of “_print._sub._ipp._tcp”/“_print._sub._ipps._tcp” using the mDNS and ends the processing (Yes in step S120 and proceeding to step S130).

On the other hand, when it is determined that the service related to the mDNS is not enabled (No in step S100), when it is determined that the IPP/IPPS port is not enabled (No in step S110), or when it is determined that the PSA function is not enabled (No in step S120), the controller 11 ends the processing without notifying the service type of “_print._sub._ipp._tcp”/“_print._sub._ipps._tcp” using the mDNS (step S140).

In step S140, when the controller 11 does not make a response of the service type of “_print._sub._ipp._tcp”/“_print._sub._ipps._tcp” using the mDNS, the OS of the client PC 30 cannot detect the multifunction peripheral 10.

That is, when the mDNS is enabled (Yes in step S100), the IPP/IPPS port is enabled (Yes in step S110), and the PSA function is enabled (Yes in step S120), the controller 11 of the multifunction peripheral 10 makes a response related to the mDNS service type. In a condition other than the above conditions (for example, the IPP/IPPS port is not enabled (No in step S110)), the OS of the client PC 30 cannot detect the multifunction peripheral 10.

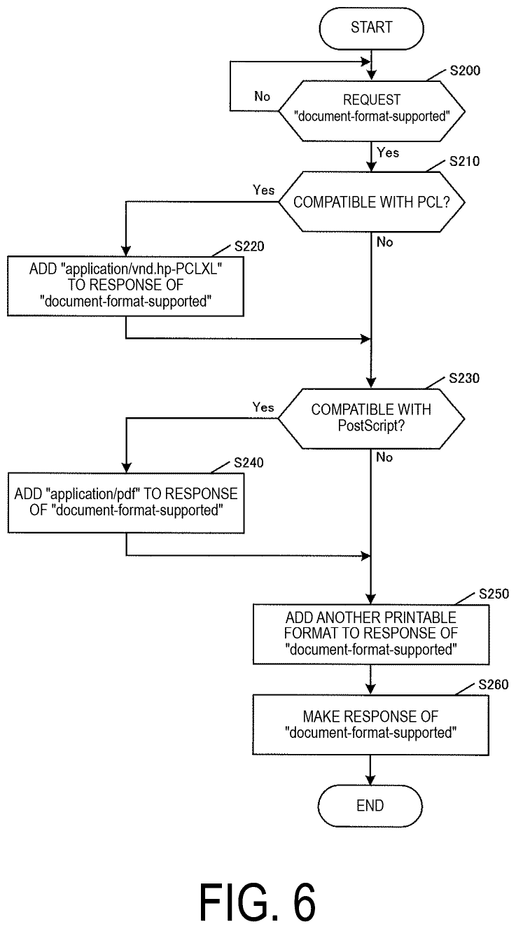

Next, a procedure at the time of adding the multifunction peripheral 10 to the client PC 30 will be described with reference to a flowchart of FIG. 6.

The controller 11 of the multifunction peripheral 10 determines whether or not a response of “document-format-supported” to a “Get-Printer-Attributes” operation from the OS of the client PC 30 is requested (step S200). When it is determined that the response of “document-format-supported” is not requested, the controller 11 waits until receiving the request of “document-format-supported” (No in step S200).

When it is determined that the response of “document-format-supported” is requested, the controller 11 determines whether or not the image processor 17 has a capability to be compatible with PCL (Yes in step S200 and proceeding to step S210). When it is determined that the image processor 17 has a capability to be compatible with PCL and that document data described in PCL can be interpreted, the controller 11 adds “application/vnd.hp-PCLXL” to the response of “document-format-supported” (Yes in step S210 and proceeding to step S220). Then, the controller 11 transitions the processing to step S230.

On the other hand, when it is determined that the image processor 17 has no capability to be compatible with PCL and that document data described in PCL cannot be interpreted, the controller 11 determines whether or not the image processor 17 has a capability to be compatible with PostScript (No in step S210 and proceeding to step S230). When it is determined that the image processor 17 has a capability to be compatible with PostScript and that document data described in PostScript can be interpreted, the controller 11 adds “application/pdf” to the response of “document-format-supported” (Yes in step S230 and proceeding to step S240). Then, the controller 11 transitions the processing to step S250.

On the other hand, when it is determined that the image processor 17 has no capability to be compatible with PostScript and that document data described in PostScript cannot be interpreted, the controller 11 adds another printable format to the response of “document-format-supported” (No in step S230 and proceeding to step S250).

Then, the controller 11 makes the response of “document-format-supported” and ends the processing (step S260).

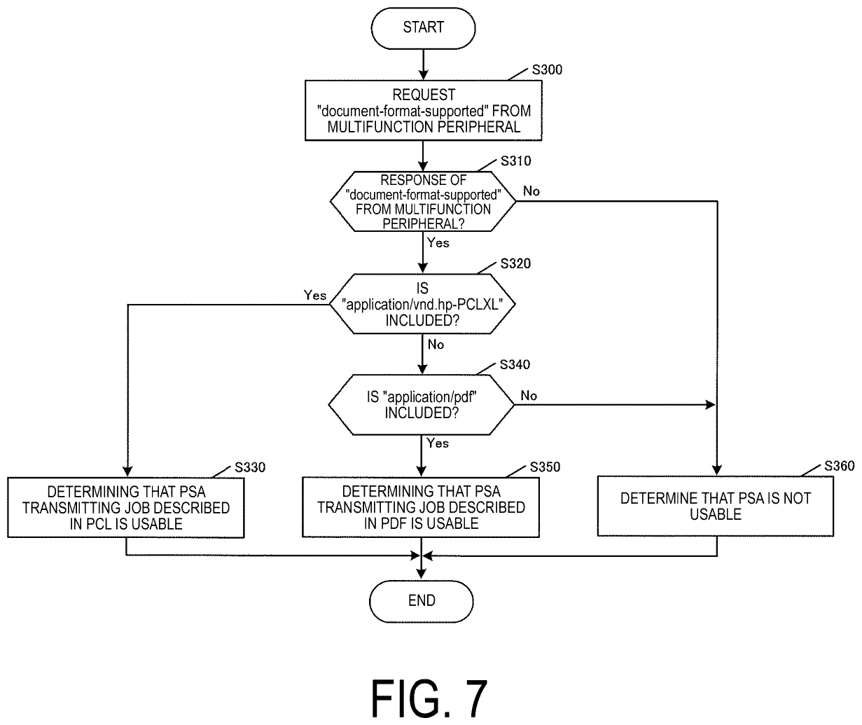

Next, a procedure in the client PC 30 at the time of addition of the multifunction peripheral 10 will be described with reference to a flowchart of FIG. 7. The controller 31 of the client PC 30 reads the support application program 3921, so that the PSA operating on the OS executes the processing described with reference to FIG. 7.

The PSA of the client PC 30 requests a response of “document-format-supported” to a “Get-Printer-Attributes” operation from the multifunction peripheral 10 (step S300).

When it is determined that there is a response of “document-format-supported” from the multifunction peripheral 10, the PSA of the client PC 30 determines whether or not “application/vnd.hp-PCLXL” is added to the response of “document-format-supported” (Yes in step S310 and proceeding to step S320).

When it is determined that “application/vnd.hp-PCLXL” is added to the response of “document-format-supported”, the PSA of the client PC 30 determines that the PSA transmitting document data described in document format PCL to the multifunction peripheral 10 as a print job is usable (Yes in step S320 and proceeding to step S330).

On the other hand, when it is determined that “application/vnd.hp-PCLXL” is not added to the response of “document-format-supported”, the OS of the client PC 30 determines whether or not “application/pdf” is added to the response of “document-format-supported” (No in step S320 and proceeding to step S340).

When it is determined that “application/pdf” is added to the response of “document-format-supported”, the PSA of the client PC 30 determines that the PSA transmitting document data described in document format PostScript (PDF) to the multifunction peripheral 10 as a print job is usable (Yes in step S340 and proceeding to step S350).

When it is determined that there is no response of “document-format-supported” from the multifunction peripheral 10 (No in step S310) or when it is determined that “application/pdf” is not added to the response of “document-format-supported” (No in step S340), the PSA of the client PC 30 determines that the PSA is not usable (step S360).

### 1.4 Operation Example

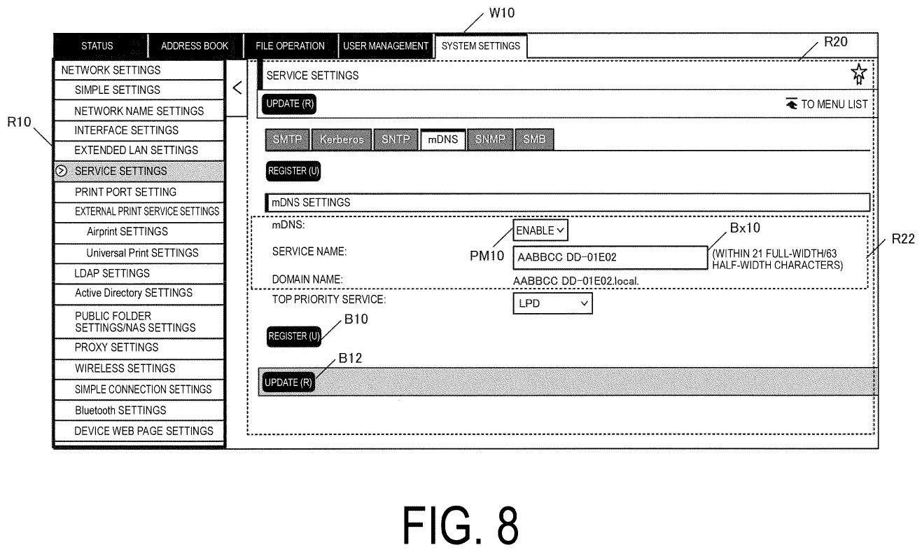

Next, operation examples according to the first embodiment will be described. FIG. 8 is a diagram for explaining an example of a display configuration of a system setting screen W10 for receiving mDNS settings. The system setting screen W10 is a screen that the controller 11 of the multifunction peripheral 10 displays upon receipt of an instruction to display the system setting screen W10 from the user. The system setting screen W10 includes a setting item selection region R10 and a service setting region R20.

The system setting screen W10 illustrated as an example in FIG. 8 is a setting screen for receiving settings related to a network. The service setting region R20 is a setting region that the controller 11 displays when service settings (displayed in a highlighted color in the drawing) are selected in the setting item selection region R10. The service setting region R20 includes an mDNS setting region R22 for receiving mDNS settings, a registration (U) button B10, and an update (R) button B12.

The mDNS setting region R22 includes a pull-down menu PM10 for receiving a setting of enabling/disabling the mDNS and a service name input box Bx10.

The user can switch between enabling and disabling of the mDNS by selecting enabling or disabling of the pull-down menu PM10. The service name input box Bx10 is an input box for receiving input of the name of a service to be provided, and FIG. 8 illustrates an example in which the name “AABBCC DD-01E02” of the multifunction peripheral 10 is input as the service name.

The registration (U) button B10 is a button for receiving a registration instruction related to the mDNS settings. The update (R) button B12 is a button for receiving an instruction to update the existing mDNS settings.

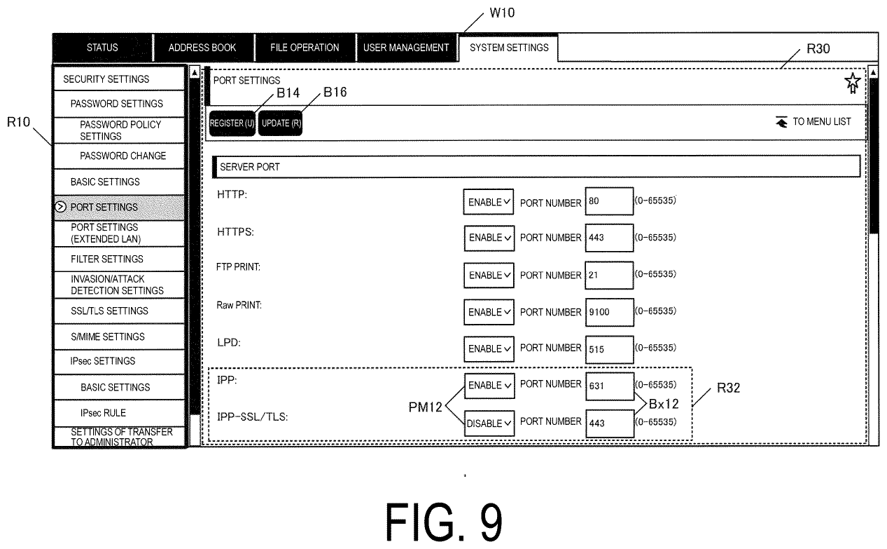

The system setting screen W10 illustrated as an example in FIG. 9 is a setting screen for receiving settings related to security. A port setting region R30 is a setting region that the controller 11 displays when port settings (displayed in a highlighted color in the drawing) are selected in the setting item selection region R10. The port setting region R30 includes a setting region R32 of the IPP and the like for receiving port settings of the IPP and IPP-SSL/TLS, a registration (U) button B14, and an update (R) button B16.

The setting region R32 of the IPP and the like includes a pull-down menu PM12 for receiving a setting of enabling/disabling the IPP or IPP-SSL/TLS, and a port number input box Bx12.

The user can switch between enabling and disabling of the IPP or IPP-SSL/TLS by selecting enabling or disabling of the pull-down menu PM12. The port number input box Bx12 is an input box for receiving input of a port number to be used for the IPP or IPP-SSL/TLS, and FIG. 9 illustrates an example in which 631 is input as a port number related to the IPP and 443 is input as a port number related to the IPP-SSL/TLS.

The registration (U) button B14 is a button for receiving a registration instruction related to the port settings. The update (R) button B16 is a button for receiving an instruction to update the existing port settings.

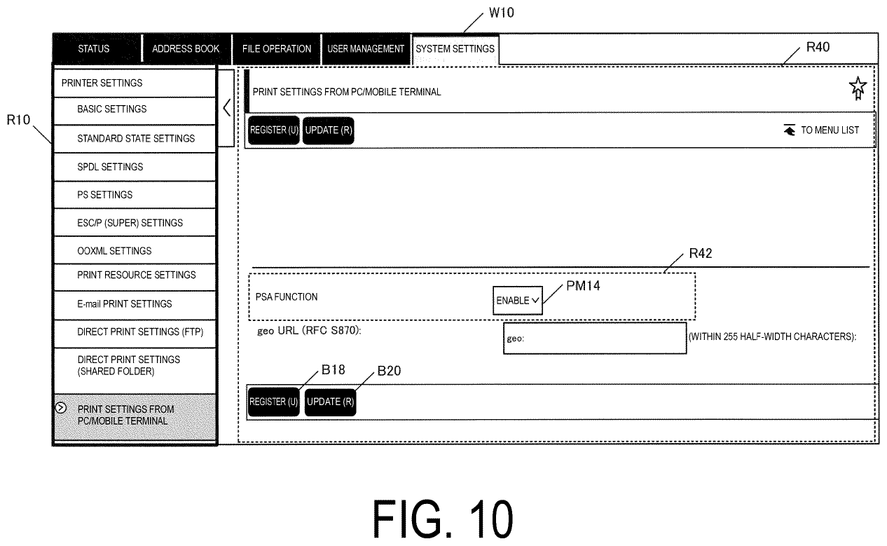

The system setting screen W10 illustrated as an example in FIG. 10 is a setting screen for receiving settings related to a printer. A region R40 for print settings from a PC/mobile terminal is a setting region that the controller 11 displays when the print settings from the PC/mobile terminal (displayed in a highlighted color in the drawing) are selected in the setting item selection region R10. The region R40 for the print settings from the PC/mobile terminal includes a PSA setting region R42 for receiving a setting of enabling/disabling PSA settings, a registration (U) button B18, and an update (R) button B20.

The PSA setting region R42 includes a pull-down menu PM14 for receiving a setting of enabling/disabling the PSA.

The user can switch between enabling and disabling of the PSA by selecting enabling or disabling of the pull-down menu PM14.

The registration (U) button B18 is a button for receiving a registration instruction related to the PSA settings. The update (R) button B20 is a button for receiving an instruction to update the existing PSA settings.

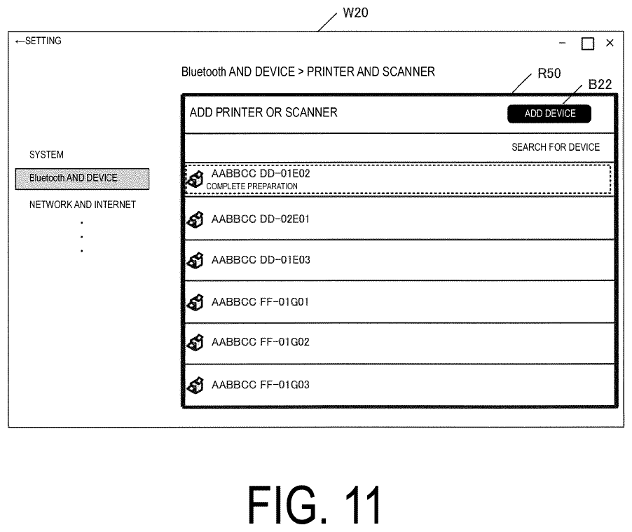

FIG. 11 is a diagram for explaining an example of a display configuration of a reception screen W20 for receiving addition of the multifunction peripheral 10 (AABBCCC DD-01 E02) to the client PC 30. The reception screen W20 is configured as a setting screen provided by the OS of the client PC 30 and includes a list display region R50 for displaying a list of addable printers (multifunction peripherals). A device addition button B22 is provided in the list display region R50. After selecting the multifunction peripheral 10 (AABBCCC DD-01 E02) desired to be added, which is indicated by a dotted line frame in the drawing, the user selects the device addition button B22, thereby allowing addition of the multifunction peripheral 10 as a printer (multifunction peripheral) capable of printing from the client PC 30.

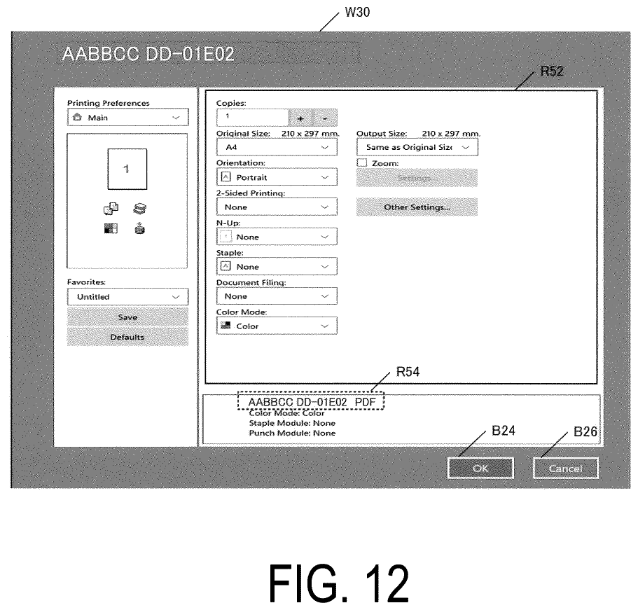

FIG. 12 is a diagram for explaining an example of a display configuration of a print setting screen W30 of the multifunction peripheral 10 added to the client PC 30. The print setting screen W30 illustrated in FIG. 12 is an example of a print setting screen when the print function is extended by the PSA and the multifunction peripheral 10 is compatible with PostScript as a document format.

The print setting screen W30 includes a print setting region R52 for receiving selection and input of print settings such as the number of copies (Copies:) and a document size (Original Size:), an OK button B24, and a Cancel button B26. The user can execute printing based on the setting values selected and input in the respective print setting items displayed in the print setting region R52. Note that providing the print setting screen W30 with a document format display region R54 indicating the document format with which the multifunction peripheral 10 is compatible enables the user to recognize the document format of document data to be output as a print job.

The OK button B24 is a button for receiving an instruction to determine the settings (setting values) set/input in the print setting region R52, and the Cancel button B26 is a button for receiving an instruction to cancel the settings (setting values) set/input in the print setting region R52.

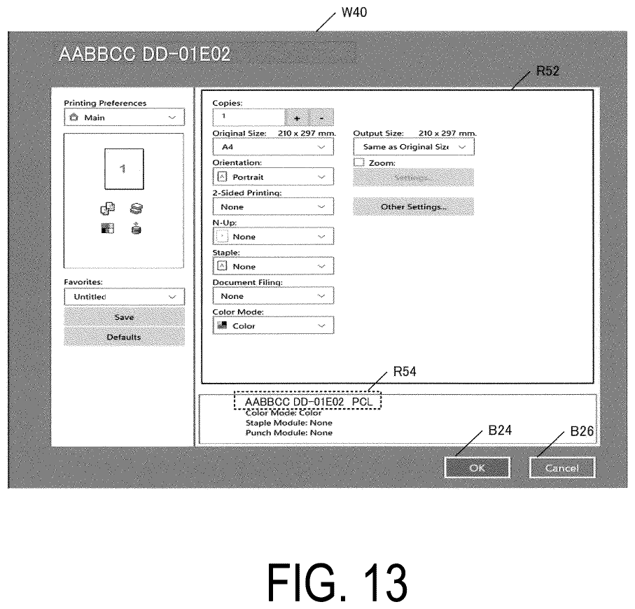

Similarly, FIG. 13 is a diagram for explaining another example of a display configuration of a print setting screen W40 of the multifunction peripheral 10 added to the client PC 30. The print setting screen W40 illustrated in FIG. 13 is an example of a print setting screen when the print function is extended by the PSA and the multifunction peripheral 10 is compatible with PCL as a document format. The document format display region R54 of the print setting screen W40 indicates that the document format with which the multifunction peripheral 10 is compatible is PCL. Since other configurations of the print setting screen W40 can be the same as those of the print setting screen W30, description thereof is omitted here.

As described above, in the first embodiment, enabling or disabling of the PSA can be set regardless of whether or not there is compatibility with PostScript. According to the first embodiment, even when the output destination of a print job is incompatible with PostScript, printing can be performed using the print function provided by the PSA when the user desires (extended) printing using the PSA.

### 2. Second Embodiment

In the first embodiment, a mode has been described in which the response of “document-format-supported” to the operation related to “Get-Printer-Attributes” is requested when the PSA is installed. In a second embodiment, a mode will be described in which a response of “document-format-supported” is requested at the time of activation of an installed PSA.

Since functional configurations of a multifunction peripheral, a client PC, and an application distribution server according to the second embodiment can be similar to the functional configurations of the multifunction peripheral 10, the client PC 30, and the application distribution server 50 according to the first embodiment, description thereof will be omitted here.

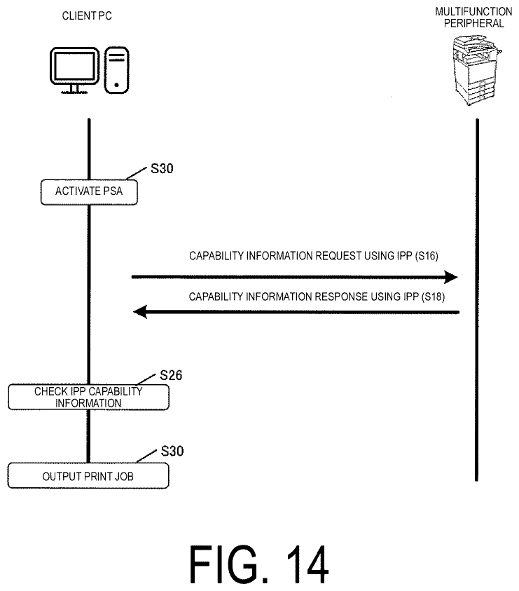

FIG. 14 is a sequence diagram for explaining processing of activating a PSA according to the second embodiment. The second embodiment will be described on the assumption that the addition processing of the multifunction peripheral 10 described with reference to FIG. 4 of the first embodiment has completed and that the multifunction peripheral 10 is activated. Note that processing operations that can be the same as those indicated by the reference signs in FIG. 4 will be described with the same reference signs.

For example, upon receipt of an activation instruction from the user, the OS of the client PC 30 activates the PSA (S30). With the activation of the PSA, the OS of the client PC 30 makes an acquisition request of capability information to the multifunction peripheral 10 using the IPP (S16).

The controller 11 of the multifunction peripheral 10 transmits the capability information as definition information to the client PC 30, thereby responding to the acquisition request (S18).

The activated PSA of the client PC 30 checks the capability information (definition information) of the multifunction peripheral 10 acquired in S18 (S26). When the capability information of the multifunction peripheral 10 checked in the S26 is different from the capability information acquired at the time of installation of the PSA, the PSA of the client PC 30 updates the capability information.

The PSA of the client PC 30 outputs a print job based on the updated capability information when the capability information of the multifunction peripheral 10 checked in the S26 is different from the capability information at the time of installation of the PSA. On the other hand, when the capability information of the multifunction peripheral 10 checked in the S26 is the same as the capability information at the time of installation of the PSA, the print job is output based on the capability information acquired at the time of installation of the PSA (S32).

As described above, according to the second embodiment, the capability information of the multifunction peripheral is acquired at the time of activation of the PSA. Thus, the PSA can execute appropriate print processing even when the PSA is installed in the client PC and then the capability of the multifunction peripheral is updated, for example, when firmware is updated or when an optional device is mounted.

### 3. Modified Example

The present disclosure is not limited to the embodiments described above and can be changed in various manners. In other words, embodiments obtained by combining technical mechanisms appropriately changed without departing from the gist of the present disclosure are also included in the technical scope of the present disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), and the like. Not only the aforementioned functions of the embodiments are implemented by executing the loaded programs, but also the functions of the present disclosure may be implemented by performing processing in cooperation with an operating system, another application program, or the like based on commands of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the present disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the present disclosure can use a new integrated circuit based on the new integrated circuit technology.

What is claimed is:

1. An image processing device comprising:
an image processor that processes document data described in a predetermined document format; and
one or more controllers that control a response to an acquisition request of capability information from a terminal device in accordance with a status of compatibility of the image processor with the predetermined document format, wherein
even when there is incompatibility with a first document format as a capability of the image processor, the one or more controllers receive a setting of enabling or disabling a print function for the document data and respond to the acquisition request of the capability information.

2. The image processing device according to claim 1, comprising:
a display, wherein
the one or more controllers receive the setting of enabling or disabling the print function via a setting screen displayed on the display.

3. The image processing device according to claim 1, wherein
as the response to the acquisition request of the capability information, the one or more controllers restrict output of definition information indicating that there is compatibility with the first document format.

4. The image processing device according to claim 1, wherein
as the response to the acquisition request of the capability information, the one or more controllers output definition information indicating that there is compatibility with a second document format.

5. The image processing device according to claim 4, wherein
the second document format includes a vendor-specific document format.

6. The image processing device according to claim 1, wherein
the print function is a print function provided by a print support application installed in the terminal device.

7. A terminal device comprising:
a storage that stores an application program supporting a print setting corresponding to an image processing device in cooperation with a printer driver;
a controller that functions as a print support application by reading the application program stored in the storage, wherein
based on capability information acquired from the image processing device, the controller outputs, to the image processing device, a print instruction in a document format with which the image processing device is compatible.

8. The terminal device according to claim 7, wherein
the controller restricts output of the print instruction when the image processing device has no compatible document format.

9. A response method comprising:
controlling a response to an acquisition request of capability information from a terminal device in accordance with a status of compatibility with a predetermined document format; and
receiving a setting of enabling or disabling a print function for document data described in the predetermined document format and responding to the acquisition request of the capability information even when there is incompatibility with a first document format as a capability of processing the document data.
